(19) United States
(12) Patent Application Publication
(10) Pub. No.: US 2021/0092641 A1
(43) Pub. Date: Mar. 25, 2021

(54) BUFFERING SUPPORT

(71) Applicant: Telefonaktiebolaget LM Ericsson (publ), Stockholm (SE)

(72) Inventors: Yong YANG, Kållered (SE); Anders P. LARSSON, Mölndal (SE); Ioannis SAPOUNTZIS, Mölndal (SE); Jiehong YANG, Mölndal (SE)

(21) Appl. No.: 16/971,780

(22) PCT Filed: Feb. 21, 2019
(86) PCT No.: PCT/EP2019/054315

§ 371 Date: Aug. 21, 2020

Related U.S. Application Data
(60) Provisional application No. 62/635,050, filed on Feb. 26, 2018.

(51) Int. Cl. H04W 28/14; H04W 28/18; H04W 72/12; H04W 4/24; H04L 12/14

(52) U.S. Cl. CPC H04W 28/14; H04W 28/18; H04L 12/1407; H04W 4/24; H04W 72/1284

(57) ABSTRACT

A packet core system includes a User Plane, UP, a Control Plane, CP and an Online Charging System, OCS. The UP and CP are split, and the UP and CP allow communication over one or more SX interfaces. The UP is adapted for initially receiving a message such as a Sx/PFCP Session Establishment Request from the CR and responding with a message such as a Sx/PFCP Session Establishment Response to the CP, and receiving a message such as a Sx/PFCP Session Modification Request from the CP and responding with message such as a Sx/PFCP Modification Response to the CP. At least one of the Sx/PFCP Session Establishment Request and the SX/PFCP Session Modification Request includes a Generic Buffering Information Element indicating a generic buffering action.

### TECHNICAL FIELD

The present invention is directed to methods and apparatuses involving Long Term Evolution, LTE technologies. In particular, the invention relates to architectures where a control plane is split from the user plane.

### BACKGROUND

The well-known SAE-LTE (System Architecture Evolution-Long Term Evolution) architecture has been shown in FIG. 1.

CUPS stands for Control and User Plane Separation of EPC nodes and provides the architecture enhancements for the separation of functionality in the Evolved Packet Core's Serving Gateway, SGW, PDN (Packet Data Network) Gateway PGW and Traffic Detection Function, TDF. This enables flexible network deployment and operation, by distributed or centralized deployment and the independent scaling between control plane and user plane functions—while not affecting the functionality of the existing nodes subject to this split.

c.f. http://www.3gpp.org/cups

Such a split is also known from 5G also denoted New Radio, NR, or Next Generation, NG systems.

CUPS allows:
reducing latency on application service, e.g. by selecting user plane nodes which are closer to the Radio Access Node, RAN, or more appropriate for the intended User Entity, UE, usage type without increasing the number of control plane nodes.
Supporting increase of Data Traffic, by enabling to add user plane nodes without changing the number of SGW-C(Control plane function), PGW-C(Control plane function) and TDF-C(Control plane function) in the network.
Locating and scaling the CP (Control Plane) and UP (User Plane) resources of the EPC nodes independently.
Independent evolution of the CP and UP functions.
Enabling Software Defined Networking to deliver user plane data more efficiently. CUPS introduces 3 new interfaces, Sxa, Sxb and Sxc between the CP and UP functions of the SGW, PGW and TDF respectively. The following high-level principles are adopted:

The CP function terminates the Control Plane protocols: GTP (GPRS Tunneling Protocol)-C, Diameter (Gx, Gy, Gz).

A CP function can interface multiple UP functions, and a UP function can be shared by multiple CP functions.

An UE is served by a single SGW-CP but multiple SGW-UPs can be selected for different PDN (Packet Data Network) connections. A user plane data packet may traverse multiple UP functions.

The CP function controls the processing of the packets in the UP function by provisioning a set of rules in Sx sessions, i.e. Packet Detection Rules for packets inspection, Forwarding Action Rules for packets handling (e.g. forward, duplicate, buffer, drop), QoS (Quality of Service) Enforcement Rules to enforce QoS policing on the packets and Usage Reporting Rules for measuring the traffic usage.

All the 3GPP features impacting the UP function (PCC (Policy and Charging Control), Charging, Lawful Interception, etc) are supported, while the UP function is designed as much as possible 3GPP agnostic. For example, the UPF (User Plane Function) is not aware of the bearer concept.

Charging and Usage Monitoring are supported by instructing the UP function to measure and report traffic usage, using Usage Reporting Rule(s). No impact is expected to OFCS (Offline Charging System), OCS (Online Charging Function) and the PCRF (Policy and Charging Rules Function).

The CP or UP function is responsible for GTP-u F-TEID (Tunnel endpoint Identifier) allocation. A legacy SGW, PGW and TDF can be replaced by a split node without effecting connected legacy nodes.

3GPP TS 23.214 Describes in Section 4.1.1—Architecture References:

“4.2.1 Non-Roaming and Roaming Architectures

This clause defines the complementary aspects of the architecture reference models specified in 3GPP documents TS 23.401 V15.2.0 (2017-12) clause 4.2 and TS 23.402 V15.2.0 (2017-12) clauses 4.2.2 and 4.2.3 for GTP-based interfaces when SGW, PGW and TDF control and user planes are separated.

For S2a, S2b, S5 and S8 reference points, this architecture reference model is only supported with GTP-based interfaces. PMIP-based interfaces and S2c interface are not supported.

Figure (corresponding to FIG. 2 in this document) 4.2.1-1 in TS 23.214 V15.1.0 (2017-12) shows the architecture reference model in the case of separation between control plane and user plane. This architecture reference model covers non-roaming as well as home routed and local breakout roaming scenarios.

NOTE 1: The -C or -U suffix appended to S2a, S2b, S5 and S8 existing reference points only indicate the control plane and user plane components of those interfaces.

NOTE 2: The architecture in FIG. 4.2.1-1 only depicts the case when the CP and UP functions of all SGW, PGW and TDF nodes are split. However, the other cases when the CP and UP function of only one of these nodes is split while the CP and UP function of the other interfacing node is not split, e.g. PGW's control plane and user plane is split while SGW's control plane and user plane is not split, are also supported. The split architecture of a node does not put any architectural requirements on the peer nodes with which it interfaces.

NOTE 3: TDF is an optional functional entity.

NOTE 4: Additional interfaces/reference points are documented in 3GPP documents TS 23.401, TS 23.402, TS 23.060 V15.1.0 (2017-12) and TS 23.203 V15.1.0 (2017-12).

NOTE 5: For a roaming architecture with local breakout, the Gx interface is defined between the PGW-C and PCRF in the visited network.

4.2.2 Combined SGW/PGW Architecture

The usage of a combined SGW/PGW documented in TS 23.401 remains possible in a deployment with separated control and user planes. This is enabled by supporting an Sx interface with a common parameter structure for non-combined and combined cases. FIG. 4.2.2-1 (corresponding to FIG. 3 in this document) shows the architecture reference model for a combined SGW/PGW in the case of separation between control plane and user plane.”

### SUMMARY

It is a first object to set forth a methods and apparatuses for providing improved and more reliable services for the purpose of improving charging reliability and end user experience.

This object has been solved by at least one of the following methods.

### BRIEF DESCRIPTION OF THE DRAWINGS

FIG. 1 shows a known reference architecture for a LTE access and core network system for a non-roaming scenario,

FIG. 2 shows a known reference architecture for a EPC system with UP/CP split,

FIG. 3 shows a known combined SGW/PGW-C with UP/CP split,

FIG. 4 shows a known signalling diagram concerning session establishment,

FIG. 5, 6 show scenarios of a reference example,

FIG. 7 shows a scenario for an embodiment of the invention,

FIG. 8 shows a known signalling diagram concerning session modification,

FIG. 9 shows additional scenarios of embodiments of the invention,

FIG. 10 shows a method according to an exemplary embodiment of the invention,

FIG. 11 show various nodes for implementing aspects of the invention, and

FIG. 12 shows an implementation of aspects of the invention in a virtualized environment.

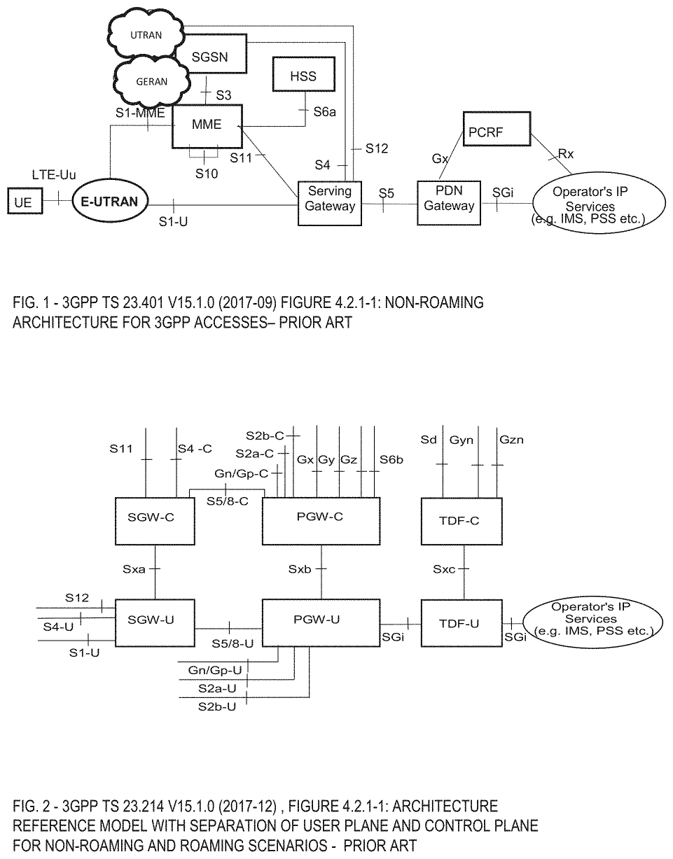

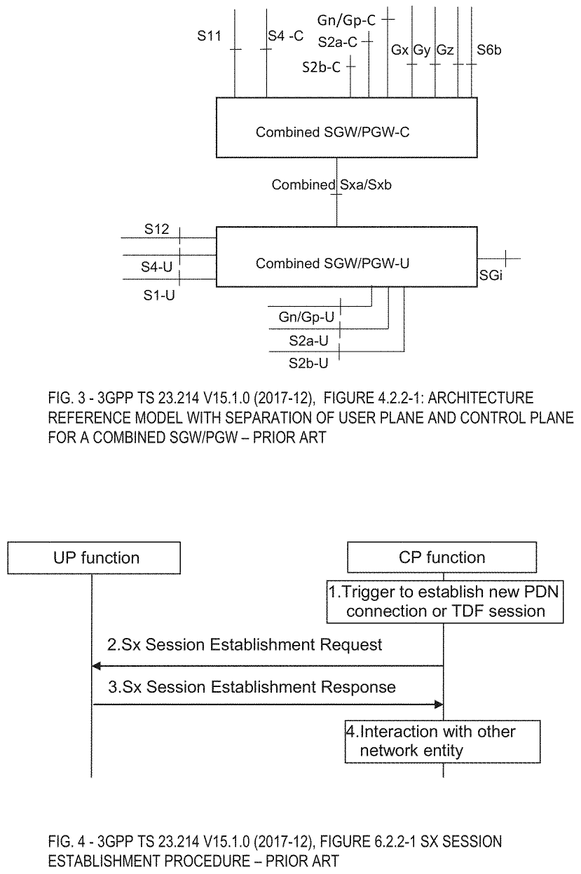

### DETAILED DESCRIPTION

In the prior art there is a drawback with the default options. ‘Drop’ leads to bad user experience, especially when the user still has credit to use; ‘Forward’ leads to risk of revenue leakage, that is the user traffic is allowed/forwarded while the user doesn't have any credit left.

The Sx specification 3GPP TS 29.244 V15.0.0 (2017-12) does not specify a buffering option for packet handling that can be used for the period when the UP awaits new instructions from the CP as in the case of initial credit authorization or credit update (signalling A-D in figures below). The “Buffer” mechanism in the current release is only designed to accommodate for the Downlink Data Notification procedure. The existing mechanism, either forward or drop packets, which can be applied for any other reason, can lead to either revenue leakage or bad user experience. With the introduction of CP/UP split and reporting in the form of URRs (Usage Reporting Rule), the UP upon reporting has to wait for new instructions from CP and in the meantime, apply a forwarding action based on a subsequent FAR (CR 0032 29.244 Rel-15) or a default action which can be either drop or forward. This is especially critical for online credit control during initial authorization as well as during an interim update due to quota exhaustion or other reporting reason.

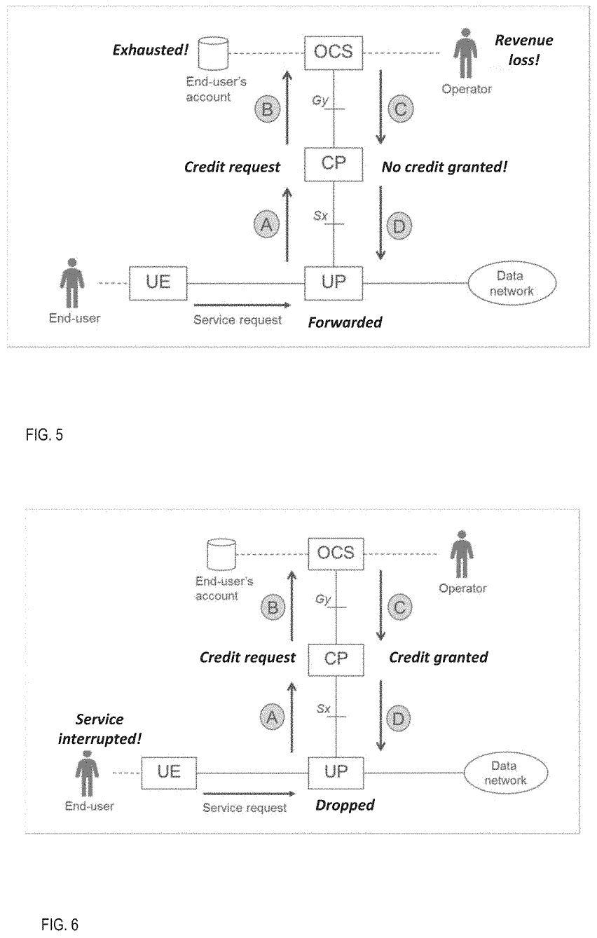

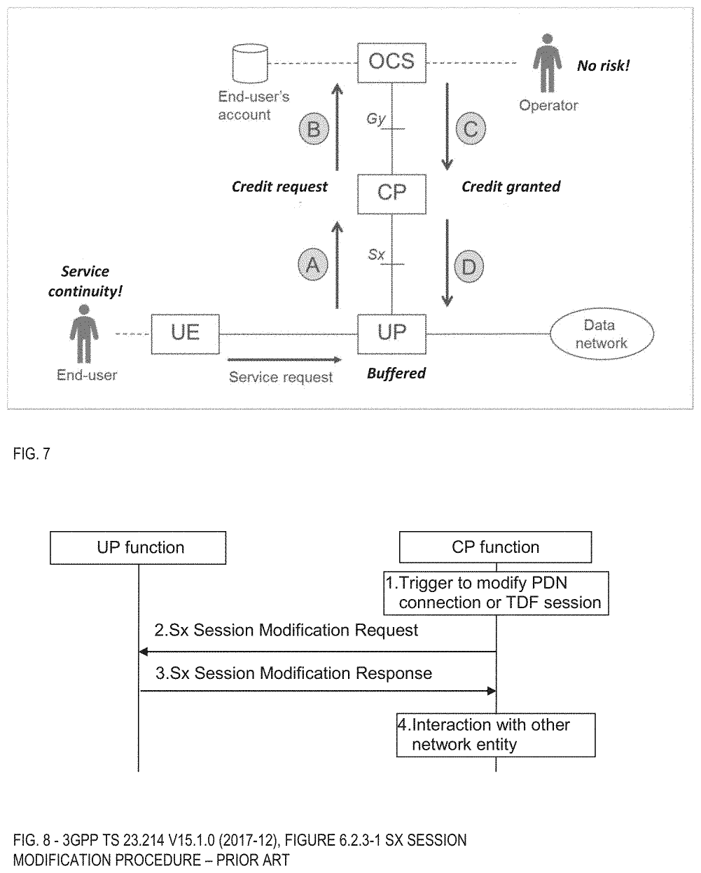

In FIG. 5, an embodiment of the invention in which forwarding of packets during credit request period is shown.

CP instructs UP to forward uplink and downlink packets for the service during the credit request period, signalling A-D. An end user of a UE makes a service request on the user plane, UP. When the packet arrives at the UP node the UP node issues a credit request, A, to a control plane, CP, node, while forwarding the packet to the data network, DN. The CP node forwards the credit request to the Online Charging System, OCS, that in this case checks the end-users account and learns that is exhausted. The OCS followingly issues a No Credit Granted Message C to the CP, which forwards, D, the message further to the UP. At this time the packet has already been forwarded to the Data Network, DN and the operator suffers a revenue loss.

In FIG. 6, a drop of packets during credit request period. CP instructs UP to drop uplink and downlink packets for the service during the credit request period, signalling A-B, similar to above. In this example, however, the end-user has enough credit and a Credit Granted message C is issued by OCS toward CP and forwarded D to UP. The content delivery is interrupted and resending needs to be initiated at application or transport level. The packet dropping therefore leads to a bad user experience

To avoid the above problems, a ‘Buffer’ mechanism is provided according to embodiments of the invention at the UP, in addition to ‘Drop’ and ‘Forward’, which can be used, among other reasons, when waiting for credit authorization/update from CP. According to embodiments of the invention, CP is enabled to instruct the UP to apply this buffering mechanism when it is applicable and decide how many packets should be buffered.

This general buffering mechanism can be used for example when the UP is waiting for new credit instruction from CP in order to handle all traffic for the affected services. It will adopt the concept and definition for FAR and BAR that is specified by 29.244, with some extensions. The concept and method invented here can be extended to any use case where UP is waiting for new instructions from CP and buffering is one of the choice that can be made. It doesn't have to be limited to the case of credit control that is exemplified most here.

In Create/Update PDR, a new IE ‘Generic Buffering’ shall be added. This should be mutually exclusive with the IEs relating to the DDN. The Generic Buffering applies to both UL and DL packets, so it can be present in FARs referenced by PDRs representing UL and DL traffic. A BAR including this Generic Buffering can be applied for example when waiting for initial credit authorization, that is when a URR report due to ‘start of service’ trigger is sent to the CP. In this case, CP must contact the OCS to request quota for the detected service, and then answer back to UP about whether the service is allowed to continue or not; the round trip UP->CP->OCS->CP>UP could be long, especially when CP and UP is geographically split. The same mechanism can be used when a URR is reported to the CP due to reaching a volume limit. The BAR can be used as part of the subsequent FAR based on the definition found in CR 0032 29.244 Rel-15.

If a BAR with ‘Generic Buffering’ included is associated to this PDR (via the FAR that is at the moment applicable to the PDR), the packets matching the PDR must be buffered, instead of dropped or forwarded, until the CP modifies the PDR with a new FAR. When the new instruction is received from CP, UP shall stop buffering and apply the new FAR. It shall also decide to either Forward or Drop the buffered packets based on the new FAR.

Using Create BAR in Sx Session Establishment Request or a Sx Session Modification as an Example:

| | |
|---|---|
| Octet 1 and 2 | Create BAR IE Type = 85 (decimal) |
| Octets 3 and 4 | Length = n |

| | | | Appl. | | | |
|---|---|---|---|---|---|---|
| Information | | | Sx | Sx | Sx | |
| elements | P | Condition/Comment | a | b | c | IE Type |
| BAR ID | M | This IE shall uniquely identify the BAR | X | — | — | BAR ID |
| | | provisioned for that Sx session. | | | | |
| Downlink Data | C | This IE shall be present if the UP function | X | — | — | Downlink |
| Notification | | indicated support of the Downlink Data Notification | | | | Data |
| Delay | | parameter (see subclause 8.2.28) and | | | | Notification |
| | | the UP function has to delay the notification to | | | | Delay |
| | | the CP function about the arrival of DL data | | | | |
| | | packets. | | | | |
| | | When present, it shall contain the delay the UP | | | | |
| | | function shall apply between receiving a down- | | | | |
| | | link data packet and notifying the CP function | | | | |
| | | about it, when the Apply Action parameter | | | | |
| | | requests to buffer the packets and notify the CP | | | | |
| | | function. | | | | |
| Generic | C | The UP can buffer packets until instructed | | X | | Generic |
| Buffering | | otherwise by the CP. If generic buffering is not | | | | Buffering |
| | | supported by the UP, it should be silently | | | | |
| | | discarder by UP. | | | | |
| | | When present, it shall contain the number of | | | | |
| | | packets that are allowed to be buffered when | | | | |
| | | the Apply Action parameter requests to buffer | | | | |
| | | the packets. The packets that exceed the limit | | | | |
| | | shall be discarded. | | | | |

The Generic Buffering Information Element, IE, indicates the number of packets that shall be buffered until new instructions are received from the CP. It is coded as depicted below:

According to embodiments of the invention there is provided a way of handling packets under the period of waiting for instructions from CP. It gives the opportunity to avoid Revenue leakage and to improve the end user experience.

CP will instruct UP to create a BAR with Generic Buffering and can also provide different packet count values based on the knowledge of the user (user category), current access technology (LTE or GERAN or UMTS), etc.

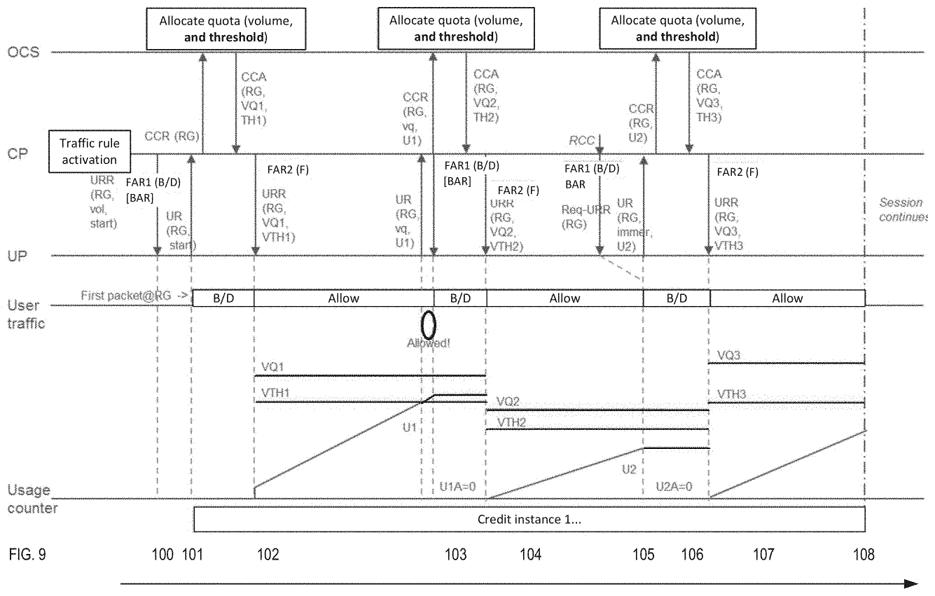

In FIG. 9, an example scenario according to embodiments of the invention is shown.

The following acronyms will be used:

### CCR—Credit Control Request

### CCA—Credit Control Answer

### URR: Usage Reporting Rule

### FAR: Forwarding Action Rule

### BAR: Buffering Action Rule

### RG: Rating Group

### VQ: Volume Quota

### TH: Threshold

### VTH: Volume Quota Threshold

### B/D: Buffer or Drop

At a traffic rule activation in the CP, CP installs URR dedicated to the RG, with volume and ‘application start’ event trigger, FAR1 (B/D)->BAR is installed as well, according to an embodiment of the invention. An URR with RG and volume start (vol. start) is issued from the CP to the UP at time 100. The UP is adapted to keep a usage counter relating to up-link traffic for a user entity, UE. This contact between CP and UP happens before a first packet arrives.

At 101, when a first up link user packet is detected, UP reports the ‘application start’ event to CP within a URR; UR (RG, Start). While waiting for the new instruction coming from CP, the UP applies the action (buffer in this case) pointed out by the FAR1 (installed above) The UP starts to buffer data packets from the UE in the UP.

The CP transmits a CCR (RG) to the OCS that allocates a quota for the UE with quota parameters Volume with value, VQ1 and threshold, with value TH1. The OCS responds to the CP with a CCA message including VQ1 and TH1. CP comes back to UP with FAR2(F), and URR (RG, VQ1, VTH1). UP now at 102 starts applying the FAR2 (Forwarding/Allowing data packets). The UP subsequently allows traffic from the UE.

Subsequent user traffic packets are received from the UE. The UP increments the usage counter while forwarding traffic as long as the VTH1 threshold is not surpassed. When VTH1 is reached, UP reports the usage to CP in CCR(RG, vq, U1)) to CP, and since quota (VQ1) is not exhausted, the traffic will be forwarded according to FAR2 until FAR1 (B/D) is received.

At 103, FAR1 is received by UP and the FAR 1 will be applied immediately in UP, according to an embodiment of the invention. OCS also receives CCR (RQ, vq, U1) substantially at this time.

The OCS allocates a new quota and responds by transmitting a CCA(RG, VQ2, TH2)—FAR1(B/D). CP transmits URR(RG, VQ2, VTH2) at time 104—FAR2(F)(Forwarding) and when received the UP opens immediately for the traffic flow again. Now also at 104, UP renews its usage counter and compares to new levels VQ2 and VTH2.

Traffic is received and counter incremented.

At 105, CP sends a Req-URR in order to pull reports from UP. In the same request, CP provisions FAR1(B/D) as well, according to an embodiment of the invention).

At 106, UP sends the report upon CP's request and applies the FAR1 after sending the report, until. new instruction FAR2 is received. The UP issues a UR(RG, immer, U2) towards CP while stopping the traffic flow and buffering packets. CP issues a CCR(RG, U2) to the OCS. The OCS assigns a new quota and transmits CCA(RG, VQ3, TH3) to CP, that again transmits FAR2(F)—URR(RG, VQ3, VTH3) to UP at 107.

When received, UP allows traffic and operates with new values VQ3 and VTH3 and starts incrementing the usage counter.

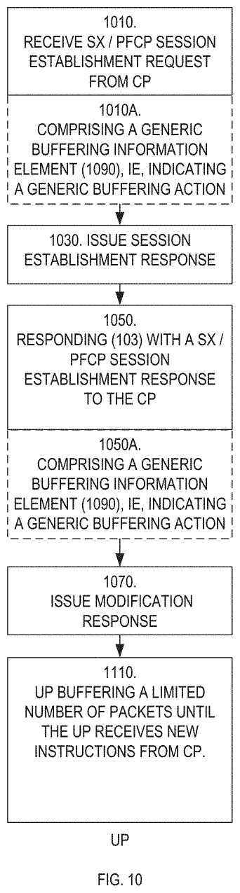

FIG. 10 shows a method according to an embodiment of the invention.

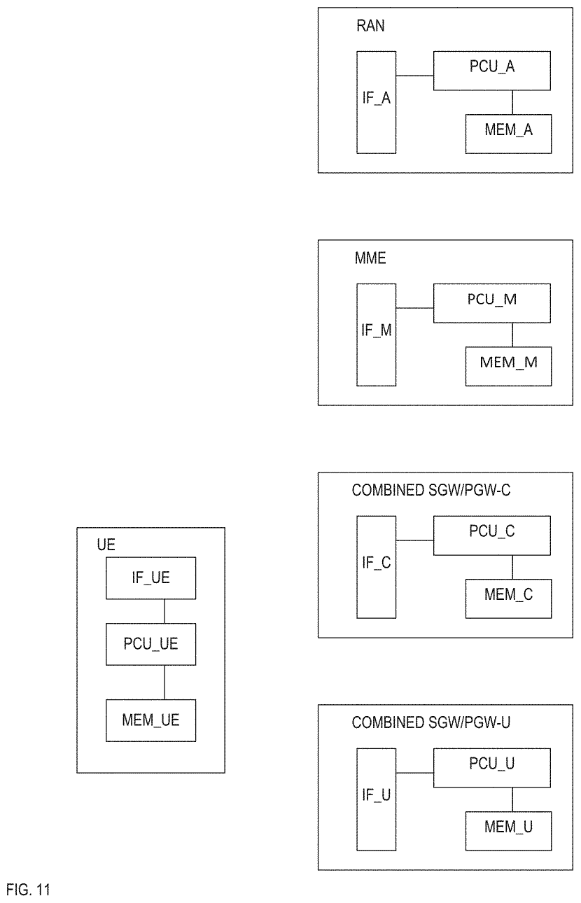

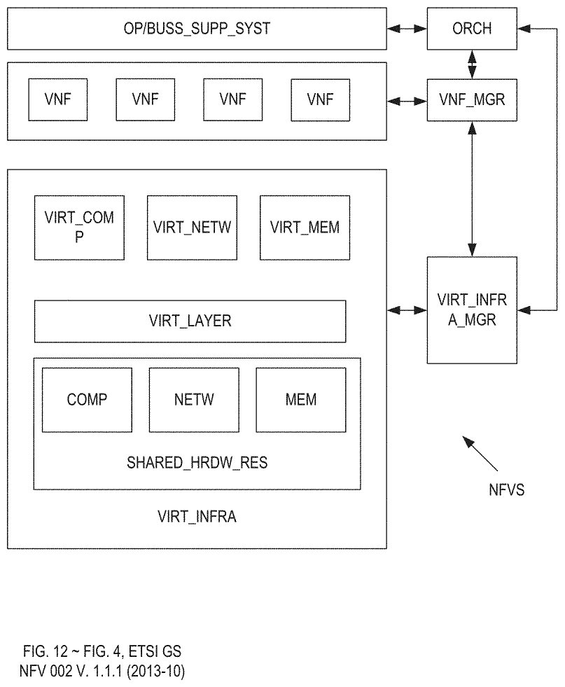

In FIG. 11, there is shown a user equipment, UE, apparatus according to the an embodiment of the invention.

The UE comprises a processor PCU_UE an interface IF_UE and a memory, MEM_UE, in which memory instructions are stored for carrying out the method steps explained above. The UE communicates via the interface IF_UE. The IF_UE comprises both an external interface, communicating with a transmitter and receiver, and internal interfaces (not shown).

There is also shown a RAN comprising a processor PCU_A, an interface IF_A; and a memory, MEM_A. Instructions are stored in the memory for being performed by the processor such that the method steps explained above are carried out and signalling is communicated on the interface.

Further, a MME is provided comprising a processor PCU_M, an interface IF_M; and a memory, MEM_M. Instructions are stored in the memory for being performed by the processor such that the method steps explained above are carried out and signalling is communicated on the interface.

In fiq. 11, there is moreover shown a Combined SGW/PGW-C comprising a processor PCU_C, an interface IF_C; and a memory, MEM_c. Instructions are stored in the memory for being performed by the processor such that the method steps explained above are carried out and signalling is communicated on the interface.

Finally, a Combined SGW/PGW-U is provided comprising a processor PCU_U an interface IF_U; and a memory, MEM_U. Instructions are stored in the memory for being performed by the processor such that the method steps explained above are carried out and such that corresponding signalling is effectuated on the interface.

The above apparatuses/entities are adapted to communicate over known external telecom interfaces or via application programming interfaces, API, as appropriate.

It is noted that the features of the methods described above and in the following, may be implemented in software and carried out on a data processing device or other processing means caused by the execution of program code means such as computer-executable instructions. Here and in the following, the term processing means comprises any circuit and/or device suitably adapted to perform the above functions. In particular, the above term comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof. For example, the program code means may be loaded in a memory, such as a RAM (Random Access Memory), from a storage medium, such as a read-only memory (ROM) or other non-volatile memory, such as flash memory, or from another device via a suitable data interface, the described features may be implemented by hardwired circuitry instead of software or in combination with software.

A computer program or computer program product is provided carrying out the method steps defined above.

The methods discussed above may alternatively be implemented by means of a system based on network functions virtualization. In FIG. 12, further embodiments of the invention are implemented by means of such a network function virtualization system, NFVS, formed on e.g. general-purpose servers, standard storage and switches. The NFVS may be arranged along the lines described in FIG. 4, ETSI GS NFV 002 V. 1.1.1 (2013-10) and comprises the following elements: A NFV management and orchestration system comprising an Orchestrator, ORCH, a VNF manager, VNF_MGR, and a virtualised Infrastructure manager, VIRT_INFRA_MGR. The NFVS moreover comprises an operational/business support system, OP/BUSS_SUPP_SYST; a number of virtual network function instances, VNF, by which the method steps explained above are instantiated; and a virtualised infrastructure, VIRT_INFRA. The VIRT_INFRA comprises a virtual computing, VIRT_COMP, virtual network; VIRT_NETW, and virtual memory, VIRT_MEM, a virtualisation layer, VIRT_LAYER, (e.g. hypervisor) and shared hardware resources, SHARED_HARDW_RES comprising computing devices, COMP, network devices, NETW, comprising e.g. standard switches and other network devices, and standard data storage devices, MEM.

1. A packet core system comprising;
a User Plane, UP, a Control Plane, CP and an Online Charging System, OCS, the UP and CP being split, the UP and CP allowing communication over one or more SX interfaces, the UP being adapted for at least on the uplink processing, such as forwarding, user plane traffic packets from a user entity, UE, towards a Data Network, DN;
the CP being adapted for controlling the processing of packets in the UP by provisioning a set of rules,
the OCS being adapted for determining a quota comprising a volume and a threshold of traffic pertaining to the UE,
the UP being adapted for
initially receiving message such as Sx/PFCP Session Establishment Request from the CP;
responding with a message such as Sx/PFCP Session Establishment Response to the CP;
receiving a message such as Sx/PFCP Session Modification Request from the CP;
responding with message such as a Sx/PFCP Modification Response to the CP;
wherein at least one of the Sx/PFCP Session Establishment Request and the SX/PFCP Session Modification Request comprises a Generic Buffering Information Element, IE, indicating a generic buffering action.

2. The packet core system according to 1, wherein the Generic Buffering IE serves to indicate a number of packets that UP shall buffer until instructed otherwise by the CP.

3. The packet core system according to 2, wherein if a generic buffering action is not supported by the UP, it should be ignored by the UP.

4. The packet core system according to claim 2, wherein the Generic Buffering IE comprises a Packet Count, indicating the number of packets that are allowed to be buffered and to indicate that packets that exceed the limit shall be discarded.

5. The packet core system according to claim 1, wherein the buffering IE is used for
initial credit authorization or credit update, and
when UP has sent a report of usage and is waiting for new instruction from CP about how the traffic shall be handled and measured.

6. A method for a packet core system comprising a User Plane, UP, a Control Plane, CP and an Online Charging System, OCS, the UP and CP being split,
the UP and CP allowing communication over one or more SX interfaces,
the UP being adapted for at least on the uplink processing, such as forwarding, user plane traffic packets from a user entity, UE, towards a Data Network, DN;
the CP being adapted for controlling the processing of packets in the UP by provisioning a set of rules,
the OCS being adapted for determining a quota comprising a volume and a threshold of traffic pertaining to the UE,
the method comprising:
initially receiving a message such as Sx/PFCP Session Establishment Request from the CP;
responding with message such as a Sx/PFCP Session Establishment Response to the CP;
receiving a message such as Sx/PFCP Session Modification Request from the CP; and
responding with message such as a Sx/PFCP Modification Response to the CP;
wherein at least one of the Sx/PFCP Session Establishment Request and the SX/PFCP Session Modification Request comprises a Generic Buffering Information Element, IE, indicating a generic buffering action.

7. The method according to 6, wherein the Generic Buffering IE serves to indicate a number of packets that UP shall buffer until instructed otherwise by the CP.

8. The method according to 7, wherein if a generic buffering action is not supported by the UP, it should be ignored by the UP.

9. The method according to claim 7, wherein the Generic Buffering IE comprises a Packet Count, indicating the number of packets that are allowed to be buffered and to indicate that packets that exceed the limit shall be discarded.

10. The method according to claim 6, wherein the buffering IE is used for
initial credit authorization or credit update, and
when UP has sent a report of usage and is waiting for new instruction from CP about how the traffic shall be handled and measured.
